(19) United States
(12) Patent Application Publication
(10) Pub. No.: US 2011/0219136 A1
(43) Pub. Date: Sep. 8, 2011

(54) INTELLIGENT AUDIO AND VISUAL MEDIA HANDLING

(75) Inventors: Lisa Seacat DeLuca, San Francisco, CA (US); Steven M. Miller, Cary, NC (US)

(73) Assignee: International Business Machines Corporation, Armonk, NY (US)

(21) Appl. No.: 12/715,818

(22) Filed: Mar. 2, 2010

(51) Int. Cl. G06F 15/16

(52) U.S. Cl. 709/231

(57) ABSTRACT

Methods, apparatus, and articles of manufacture for transmitting data. A first device defining a preferred language may be configured to receive a media stream from a second device. The second device may be configured to make public broadcasts in a plurality of languages to the first device and other devices. The second device interrupts the media stream at the first device only during transmission of the public broadcast in the preferred language.

### BACKGROUND

1. Field

The present invention is generally related to media devices, and more specifically to media devices capable of intelligently interrupting media based on a user's language preference.

2. Description of the Related Art

Media devices are frequently used by travelers as a source of entertainment while travelling on a plane, ship, train, and the like. For example, in an airplane, each seat may be equipped with an audio or an audio/video device capable of playing music, movies, and other forms of entertainment. The media devices may also be used to make public announcements. For example, the pilot may interrupt the media playing on the media devices to make public announcements regarding turbulent weather, remaining flight time, safety instructions, and the like. The public announcements may be repeated in several different languages.

### SUMMARY

The present invention is generally related to media devices, and more specifically to media devices capable of intelligently interrupting media based on a user's language preference.

One embodiment of the invention provides a method for transmitting data. The method generally comprises transmitting a media stream to a device, wherein a first language is preselected as a preferred language for the device, and transmitting a message sequentially in at least the first language and a second language. The method further comprises interrupting the media stream to the device only during transmission of the message in the first language as a result of the first language being preselected as the preferred language for the device.

Another embodiment of the invention provides another method for transmitting data. The method generally comprises transmitting a media stream to a device, wherein the media stream comprises data in a first language, transmitting a message sequentially in at least the first language and a second language, and interrupting the media stream to the device only during transmission of the message in the first language.

Yet another embodiment of the invention provides a computer readable storage medium comprising a program product which, when executed is configured to perform an operation for transmitting data. The operation generally comprises transmitting a media stream to a device, wherein a first language is preselected as a preferred language for the device, and transmitting a message sequentially in at least the first language and a second language. The operation also comprises interrupting the media stream to the device only during transmission of the message in the first language as a result of the first language being preselected as the preferred language for the device.

Another embodiment of the invention provides a system, comprising at least one first device, wherein a first language is preselected as a preferred language of the first device, and a second device. The second device is configured to transmit a media stream to the first device, transmit a message sequentially in at least the first language and a second language, and interrupt the media stream to the first device only during transmission of the message in the first language as a result of the first language being preselected as the preferred language for the device.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary system according to an embodiment of the invention.

FIG. 2 is a flow diagram of exemplary operations for transmitting data, according to an embodiment of the invention.

### DETAILED DESCRIPTION OF THE PREFERRED EMBODIMENTS

Embodiments of the invention generally provide methods, apparatus, and articles of manufacture for transmitting data. A first device defining a preferred language may be configured to receive a media stream from a second device. The second device may be configured to make public broadcasts in a plurality of languages to the first device and other devices. The second device interrupts the media stream at the first device only during transmission of the public broadcast in the preferred language.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

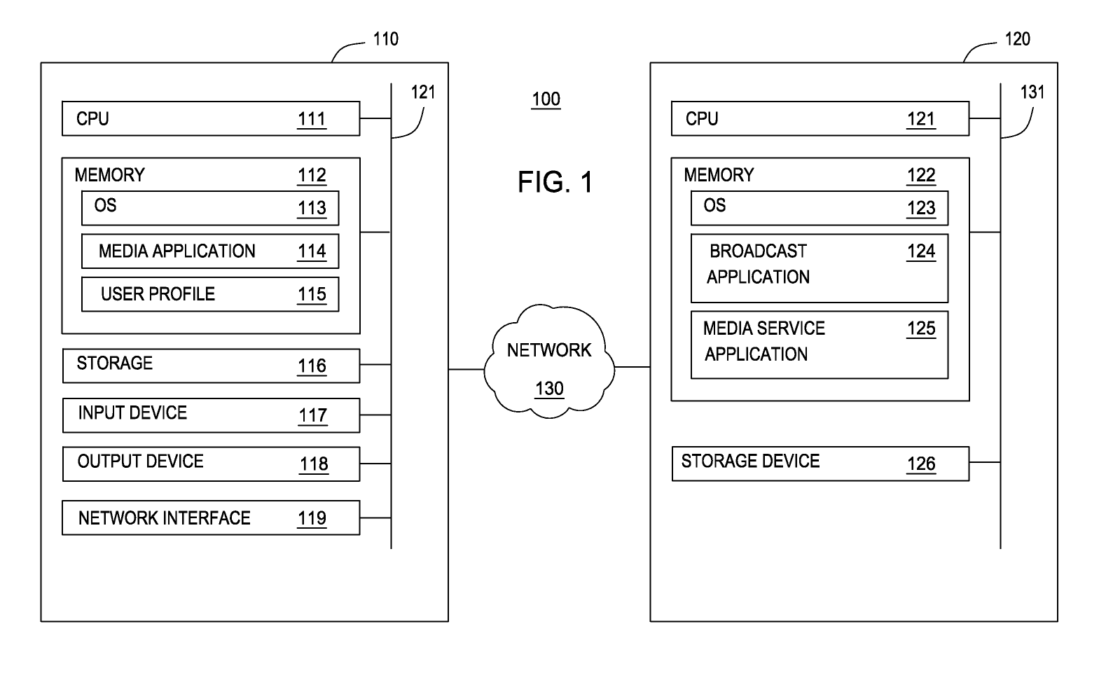

FIG. 1 illustrates a networked system 100, according to an embodiment of the invention. As illustrated in FIG. 1, the networked system 100 may include at least two devices 110 and 120 configured to communicate with each other over a network 130. In general, the network 140 may be a local area network (LAN) and/or a wide area network (WAN). In a particular embodiment, the network 130 is a personal area network configured to connect a plurality of devices within a limited area, for example, an airplane, a ship, a train, a room, a building, a stadium, or the like. The network 130 may be a wired network, a wireless network, or a combination of wired and wireless networks.

In one embodiment, each of the devices 110 and 120 may be audio and/or visual media devices, for example, televisions, telephones, music players, and the like. The devices 110 and 120 may be portable, for example, a portable television, laptop computer, personal digital assistant, cellular phone, and the like. In alternative embodiments, the devices 110 and 120 may be fixed devices such as, for example, desktop computers, internet kiosks, televisions and/or music devices on airplanes or trains, and the like.

As illustrated in FIG. 1, the device 110 includes a Central Processing Unit (CPU) 111 connected via a bus 121 to a memory 112, storage 116, an input device 117, an output device 118, and a network interface device 119. The input device 117 can be any device to give input to the device 110. For example, a keyboard, keypad, light-pen, touch-screen, track-ball, or speech recognition unit, audio/video player, and the like could be used.

The output device 118 can be any device to give output to the user, e.g., any conventional display screen. Although shown separately from the input device 117, the output device 118 and input device 117 could be combined. For example, a display screen with an integrated touch-screen, a display with an integrated keyboard, or a speech recognition unit combined with a text speech converter could be used.

The network interface device 119 may be any entry/exit device configured to allow network communications between the device 110 and device 120 via the network 130. For example, the network interface device 119 may be a network adapter or other network interface card (NIC).

Storage 116 is preferably a Direct Access Storage Device (DASD). Although it is shown as a single unit, it could be a combination of fixed and/or removable storage devices, such as fixed disc drives, floppy disc drives, tape drives, removable memory cards, or optical storage. The memory 112 and storage 116 could be part of one virtual address space spanning multiple primary and secondary storage devices.

The memory 112 is preferably a random access memory sufficiently large to hold the necessary programming and data structures of the invention. While memory 112 is shown as a single entity, it should be understood that memory 112 may in fact comprise a plurality of modules, and that memory 112 may exist at multiple levels, from high speed registers and caches to lower speed but larger DRAM chips.

Illustratively, the memory 112 contains an operating system 113. Illustrative operating systems, which may be used to advantage, include Linux (Linux is a trademark of Linus Torvalds in the US, other countries, or both) and Microsoft's Windows®. More generally, any operating system supporting the functions disclosed herein may be used. Memory 112 is also shown containing a media application 124 which may be configured to generate audio and or visual data to be displayed on an output device 118.

The memory 112 may also include one or more user profiles 115. User profiles may include data describing a user or user preferences of the device 110. For example, in one embodiment, the user profiles may store a preferred language of the user. In some embodiments, a user may be allowed to select a plurality of different languages as preferred languages.

The device 120 may by physically arranged in a manner similar to the device 110. Accordingly, the device 120 is shown generally comprising at least one CPU 121, memory 122, and a storage device 126, coupled with one another by a bus 131. Memory 122 may be a random access memory sufficiently large to hold the necessary programming and data structures that are located on device 120.

The device 120 may generally be under the control of an operating system 123 shown residing in memory 122. Examples of the operating system 123 include IBM OS/400®, UNIX, Microsoft Windows®, and the like. More generally, any operating system capable of supporting the functions described herein may be used.

The memory 122 further includes broadcast application 124 and a media service application 125. The applications 124 and 125 are software products comprising a plurality of instructions that are resident at various times in various memory and storage devices in the computer system 100. When read and executed by one or more processors 121, the applications 124 and 125 cause the computer system 100 to perform the steps necessary to execute steps or elements embodying the various aspects of the invention. While the broadcast application 124 and the media service application 125 are shown as separate applications herein, in some embodiments, the broadcast application 124 and the media service application 125 may be a part of the same application.

Storage 126 is preferably a Direct Access Storage Device (DASD). Although it is shown as a single unit, it could be a combination of fixed and/or removable storage devices, such as fixed disc drives, floppy disc drives, tape drives, removable memory cards, or optical storage. The memory 122 and storage 126 could be part of one virtual address space spanning multiple primary and secondary storage devices. In one embodiment, the memory 122 and the storage device 126 may be configured to store audio and/or visual data.

In one embodiment of the invention, the media application 114 in device 110 may be configured to request audio and/or visual data stored in the device 120. Requests for audio/visual data from the device 110 may be received by the media service application 125. In one embodiment, the media service application 125 may stream the audio/visual data (also referred to herein as a media stream) stored in memory 122 and/or storage 126 of the device 120 to the device 110 via the network 130.

In another embodiment, the media service application 125 may be configured to broadcast audio and/or visual data on a plurality of transmission channels. The media application 114 may allow a user to tune the device 110 to one of the transmission channels to receive the audio and/or visual data. For example, in an airplane, a device 120 may transmit audio/visual signals on a plurality of channels to devices 110 on each airplane seat. Passengers at each seat may be configured to tune their respective devices 110 to a desired channel to receive the audio/visual transmissions from the device 120.

In one embodiment of the invention, the device 120 may be configured to broadcast messages to the device 110 and any other devices connected to the network 130. For example, in one embodiment, the device 120 may be an intercommunication (intercom) device in an airplane, and the devices 110 may be audio/visual devices provided at each seat of an airplane. Accordingly, a pilot or other airline personnel may be able to use the device 120 to make announcements to the passengers in the airplane. The public broadcasts may be pre-recorded broadcasts, or in alternative embodiments, live broadcasts made by a user of the device 120.

The broadcasting of messages may be controlled by the broadcast application 124. In some embodiments, the broadcast application 124 may be configured to broadcast messages in a plurality of different languages. Specifically, the same message may be broadcast sequentially in each of the plurality of languages. During the pubic broadcasts, the broadcast application 124 may be configured to interrupt the transmission of audio/visual data from the device 120 to the devices 110, e.g., the audio/visual data transmitted by the media service application 125. In cases where the device 120 transmits audio/visual data on a plurality of channels, the broadcast application 124 may be configured to interrupt the transmission on each of the plurality of channels to transmit the message.

In one embodiment, the broadcast application 124 may be configured to retrieve language preference information from devices connected to the network 130 before interrupting streaming audio/visual data. For example, the broadcast application may request data from the user profiles 115 in each of the devices 110. Accordingly, in one embodiment, the broadcast application may be configured to interrupt streaming audio/visual data from the device 120 to a device 110 only when transmitting the message in a language indicated as a preferred language in the device 110.

For example, going back to the airplane example, suppose a passenger A in a first seat of the airplane sets up a user profile on a first device 110 indicating Spanish as the preferred language, and a passenger B in a second seat of the airplane sets up a user profile on a second device 110 indicating French as the preferred language. Thereafter, each of passengers A and B may use their respective devices 110 to retrieve audio/visual data, e.g., from a device 120.

During the course of the flight, one or more announcements may be made in a plurality of different languages. Each announcement may be repeated in a plurality of different languages, e.g., English, Spanish, and French (in that order). Prior to making each announcement, the broadcast application 124 may be configured to retrieve language preference information from each device 110 in the aircraft. During the broadcast of the message in English, the audio/visual data streaming to the first device 110 and the second device 110 may not be interrupted because both devices have not indicated English as a preferred language. Therefore, each of passengers A and B will be able to continue viewing their respective media streams without interruption during the broadcast of the message in English.

During the broadcast of the message in Spanish, the media stream of passenger A using the first device 110 may be interrupted because passenger A has set up the first device 110 with Spanish as the preferred language. However, the media stream at the second device 110 may not be interrupted because Spanish is not a preferred language at the second device 110. At the end of the broadcast in Spanish, the media stream may resume at the first device 110. For example, the broadcast application 124 may resume the media stream provided by the media service application 125 of the device 120 to the first device 110.

During the broadcast of the message in French, the media stream of passenger B using the second device 110 may be interrupted because passenger B has set up the first device 110 with French as the preferred language. However, the media stream at the first device 110 may not be interrupted because French is not a preferred language at the first device 110. At the end of the broadcast in French, the media stream may resume at the second device 110. Therefore, embodiments of the invention allow users of the devices 110 to view media streams during broadcasts of messages that are not indicated as preferred languages.

In one embodiment, a user may be allowed to select a plurality of different languages as preferred languages. For example, passenger A may select both English and Spanish as preferred languages at the first device 110. Accordingly, in one embodiment, the broadcast application 124 may be configured to interrupt a media stream to the first device 110 during the transmission of the message in English as well as Spanish.

In an alternative embodiment, the broadcast application 124 may be configured to interrupt the media stream at the first device in only one of the preferred languages. Any reasonable criteria may be used to select a specific language from a plurality of preferred languages. For example, in one embodiment, the broadcast application 124 may include a predefined order of languages, and may transmit a message in the first language in the predefined order that is also indicated as a preferred language in a device 110.

In one embodiment, the media application 114 of each device 110 may be configured to generate a graphical user interface (GUI) to allow a user to select preferred languages. The GUI screen may be generated at start-up of the device 110, during or after user log-in, after each restart, and the like. In one embodiment, the GUI may be a GUI screen for entering user profile information, e.g., to create a user profile 115. In an alternative embodiment, the GUI may be associated with a settings window for the device 110.

In one embodiment, the broadcast application 124 may be configured to interrupt a media stream from the device 120 to a device 110 only during transmission of a message in the same language as the language of the media stream. For example, in the above airplane example, if passenger B is listening to Spanish music or Spanish television, the broadcast application 124 may interrupt the media stream to the second device 110 only during transmission of a message in Spanish.

While embodiments of the invention are described with reference to media and other message transmissions on an airplane, embodiments of the invention are not limited to use only on airplanes. Other examples where embodiments of the invention can advantageously be employed include stadiums, conference rooms, other forms of public transportation, buildings, or the like where transmission of messages in a plurality of languages are made.

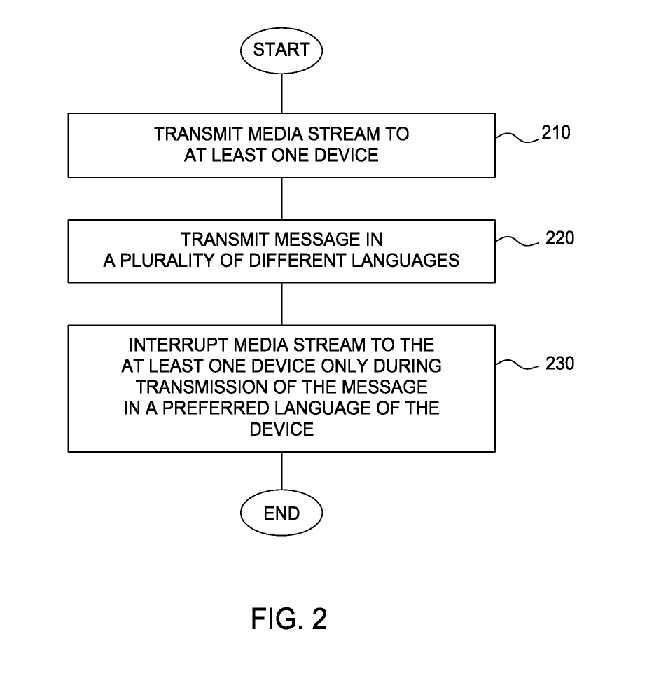

FIG. 2 is a flow diagram of exemplary operations performed by a device 120, according to an embodiment of the invention. The operations may begin in step 210 by transmitting a media stream to at least one device 110. For example, a media service application 125 may stream video and/or audio data to the device 110 upon request. In step 220, the device 120 may transmit a message sequentially in a plurality of different languages. For example, the broadcast application 124 may broadcast a message to a plurality of devices 110 connected to a network 130. In step 230, the device 120 may interrupt a media stream to the at least one device 110 only during transmission of the message in a language indicated as a preferred language at the device 110.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A method for transmitting data, comprising:
transmitting a media stream to a device, wherein a first language is preselected as a preferred language for the device;
transmitting a message in at least the first language and a second language; and
interrupting the media stream to the device only during transmission of the message in the first language.

2. The method of claim 1, further comprising resuming transmission of the media stream after completion of transmission of the message in the first language.

3. The method of claim 1, wherein the device defines the first language as a preferred language in a user profile.

4. The method of claim 3, further comprising accessing the user profile in the device to determine the preferred language of the device.

5. The method of claim 1, wherein the device defines the first language as a preferred language in settings of the device.

6. A method for transmitting data, comprising:
transmitting a media stream to a device, wherein the media stream comprises data in a first language;
transmitting a message in at least the first language and a second language; and
interrupting the media stream to the device only during transmission of the message in the first language.

7. The method of claim 6, further comprising resuming transmission of the media stream after completion of transmission of the message in the first language.

8. A computer readable storage medium comprising a program product which, when executed is configured to perform an operation for transmitting data, comprising:
transmitting a media stream to a device, wherein a first language is preselected as a preferred language for the device;
transmitting a message in at least the first language and a second language; and
interrupting the media stream to the device only during transmission of the message in the first language.

9. The computer readable storage medium of claim 8, wherein the operation further comprises resuming transmission of the media stream after completion of transmission of the message in the first language.

10. The computer readable storage medium of claim 8, wherein the device defines the first language as a preferred language in a user profile.

11. The computer readable storage medium of claim 10, wherein the operation further comprises accessing the user profile in the device to determine the preferred language of the device.

12. The computer readable storage medium of claim 8, wherein the device defines the first language as a preferred language in settings of the device.

13. A system, comprising:
at least one first device, wherein a first language is preselected as a preferred language of the first device; and
a second device configured to:
transmit a media stream to the first device;
transmit a message in at least the first language and a second language; and
interrupt the media stream to the first device only during transmission of the message in the first language.

14. The system of claim 13, wherein the second device is further configured to resume transmission of the media stream after completion of transmission of the message in the first language.

15. The system of claim 13, wherein the first device defines the first language as a preferred language in a user profile.

16. The system of claim 15, wherein the second device is further configured to access the user profile in the first device to determine the preferred language of the device.

17. The system of claim 13, wherein the first device defines the first language as a preferred language in settings of the device.

18. The system of claim 13, wherein the second device is an intercommunication device.

19. The system of claim 13, wherein the first device is configured to generate a graphical user interface to receive selections of preferred languages.

20. The system of claim 13, wherein the second device is configured to transmit a plurality of media streams on a plurality of channels, and interrupt the plurality of media streams on one or more of plurality of channels during transmission of the message in the first language.
